(19) United States
(12) Patent Application Publication
(10) Pub. No.: US 2026/0116792 A1
(43) Pub. Date: Apr. 30, 2026

(54) Alternate Water Distributions in Electrodialysis Systems with ZLD Properties

(71) Applicant: Ben Harrison Cantrell, Springfield, VA (US)

(72) Inventor: Ben Harrison Cantrell, Springfield, VA (US)

(21) Appl. No.: 18/679,573

(22) Filed: May 31, 2024

(51) Int. Cl. C02F 1/469

(52) U.S. Cl. CPC C02F 1/4693; C02F 2201/4611; C02F 2201/46115

(57) ABSTRACT

This invention provides new ways of distributing dilute and concentrate waters to the spaces between cation and anion ion exchange membranes in an electrodialysis system. An external attached manifold is used to distribute-and-retrieve concentrate water to-and-from each concentrate water space, which by the design of components can mitigate the power lost in the concentrate water distribution system. Furthermore, the dilute water is externally and simultaneously distributed to the dilute water spaces, that are between the adjacent anion and cation ion exchange membranes in the electrodialysis stack of components, and the thickness of the dilute water spaces can be kept to be as low as on-the-order-of one-tenth-inch while maintaining good dilute water flow rates. Finally, this invention provides a means of obtaining Zero Liquid Discharge ZLD desalination operation.

### CROSS-REFERENCE TO RELATED APPLICATIONS

Patent application Ser. No. 18/128,382, Ben Harrison Cantrell, “Gated Electrodialysis with Zero Liquid Discharge,” Filed Mar. 30, 2023

### FEDERALLY SPONSORED RESEARCH OR DEVELOPMENT

Not applicable

### REFERENCE TO A “SEQUENCE LISTING”

Not Applicable

### NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND

### Field of the Invention

This invention is in the field of electrodialysis with applications to desalination.

### Description of the Related Art

Electrodialysis has been employed for more than fifty years in a variety of applications to transfer ions from a dilute ionized water solution to a concentrate ionized water solution as described in Citation 1 in INFORMATION DISCLOSURE STATEMENT BY APPLICANT Form PTO/SB/08a (01-10) under NON-PATENT LITERATURE DOCUMENTS. Very briefly, the electrodialysis process relies on the property that cations pass through, while anions cannot pass through cation ion exchange membranes and anions pass through, while cations cannot pass through anion ion exchange membranes, when the cations and anions are under the influence of an electric field. In an ordinary electrodialysis configuration, there is a stack of alternating dilute and concentrate water spacers holding dilute and concentrate water respectively, which are separated by alternating cation and anion ion exchange membranes. The dilute water is internally fed and retrieved from one dilute space to the next dilute space through holes in the adjacent concentrate water spacers and ion exchange membranes. Likewise, concentrate water is internally fed and retrieved from one concentrate water space to the next concentrate water space through holes in the adjacent dilute water spacers and ion exchange membranes.

This invention simultaneously distributes and retrieves the concentrate water to-and-from each concentrate water space using a thick attached manifold rather than internally passing the concentrate water from one concentrate water space to the next through the adjacent dilute water spacers and ion exchange membranes like ordinary electrodialysis systems does. By appropriately setting the parameters of the attached manifold, the power lost in the new concentrate water distribution system can be mitigated even when the concentrate water is supersaturated, but below the salt concentration levels where spontaneous precipitation would occur. Furthermore, unlike ordinary electrodialysis systems, this invention externally and simultaneously distributes-and-retrieves the dilute water to-and-from each dilute water space rather than internally passing the dilute water from one dilute space to the next through adjacent concentrate water spacers and ion exchange membranes. This new dilute water distribution system creates narrow spaces between the cation and anion ion exchange membranes and yet good dilute water flow is maintained. Finally, an example application for this invention, that will provide Zero Liquid Discharge ZLD operation, is described.

### BRIEF SUMMARY OF THE INVENTION

Unlike ordinary electrodialysis systems, this invention is constructed so that the concentrate water is simultaneously fed-and-retrieved through a thick attached manifold to-and-from each individual concentrate water space while mitigating the power loss in the concentrate water distribution system even when the concentrate water is supersaturated, but below the salt concentration levels where spontaneous precipitation would occur. Furthermore, the dilute water is externally and simultaneously fed-and-retrieved between either two concentrate water assemblies or a concentrate water assembly and an electrode assembly and the thickness of the dilute water can be as small as on-the-order-of one-tenth-inch, while yet maintaining good dilute water flow rates. The construction of a prototype unit is described, but larger or smaller sized units could be constructed.

The major components of this invention's electrodialysis stack are (1) concentrate water assemblies, (2) cathode assembly, (3) anode assembly, and (4) concentrate water manifolds, which consist of manifold faceplates and manifold covers.

The concentrate water assembly consists of a retainer sheet, anion ion exchange membrane, inner spacer, cation ion exchange membrane, and another retainer sheet all bonded together. The flat inner spacer is made from plastic has outer dimensions on-the-order-of one-to-five-feet wide, on-the-order-of one-to-five-feet high, and on-the-order-of one-inch thick. Looking at the inner spacer's front side, all the space except a border on-the-order-of one-inch wide is an empty space. The inners spacer's left and right edges have holes on-the-order-of one-half-inch in diameter all the way into the empty space and are equally spaced along the left and right edges except in the region where a hole would not go into the empty space. There are also on-the-order-of one-fourth-inch diameter threaded holes along the left and right edges of the inner spacer whose depth will not penetrate the empty space. These holes are near the top and bottom of the left and right edges and in between the on-the-order-of on-half-inch holes. The flat retainer sheet is made from plastic, has the same width and height as the inner spacer, is on-the-order-of thirty-mils thick, and consists mostly of holes from about one-half-inch to two-inch in diameter viewed from its front side. The flat anion and cation ion exchange membranes have the same width and height as the inner spacer and are about twenty-mils thick. Observing the assembled concentrate water assembly, concentrate water will flow through the on-the-order-of one-half-inch diameter holes on the left edge of the inner spacer, through the empty space of the inner spacer having cation and anion ion exchange membranes followed by retainer sheet walls, and through the on-the-order-of one-half-inch diameter holes on the right edge of the inner spacer.

The cathode and anode assemblies consist of some combination of inner spacers, outer spacers, retainer sheets, electrode covers, electrodes, an anion ion exchange membrane, and cation ion exchange membranes. The inner spacers are identical to the outer spacers except they have no on-the-order-of one-half-inch holes on their left and right edges. The electrode covers have the same width and height of the inner and outer spacers, but are on-the-order-of one-fourth-inch thick. There are electrodes, that have the same width and height as the empty space in the inner and outer spacers and are on-the-order-of one-eighth-inch thick. The electrodes are mounted in the central region on the back side of the electrode covers. There is an electrode connector from the electrode to the front of the electrode cover. There is a water inlet hole and fitting near the bottom and a water outlet hole and fitting near the top on the front of each electrode cover.

The cathode assembly consists of an electrode cover with attached electrode, outer spacer, cation ion exchange membrane, and retainer sheet all bonded together. In the cathode assembly, electrolysis water will flow into the electrode cover's front input fitting near its bottom, flow upward in the empty space of the outer spacer having an electrode and a cation ion exchange membrane followed by a retainer sheet as walls, and out the electrode cover's front output fitting near its top.

The anode assembly consists of an electrode cover with attached electrode, outer spacer, retainer sheet, cation ion exchange membrane, inner spacer, anion ion exchange membrane, and retainer sheet all bonded together. Observing the assembled anode assembly, concentrate water will flow through the on-the-order-of one-half-inch diameter holes on the left edge of the inner spacer, through the mostly empty space of the inner spacer having cation and anion ion exchange membranes followed by retainer sheet walls, and through the on-the-order-of one-half-inch diameter holes on the right edge of the inner spacer. Electrolysis water will flow into the electrode cover's front input fitting near its bottom, flow upward in the empty space of the outer spacer having an electrode and a cation ion exchange membrane followed by a retainer sheet as walls, and out the electrode cover's front output fitting near its top.

The manifolds, which will distribute or combine concentrate waters, consist of a manifold faceplate and a manifold cover. The manifold faceplates and manifold covers are made from plastic and their width is the sum of the thicknesses of the concentrate water assemblies, cathode assembly, anode assembly and the designated spaces that will be left between them. Their height is the same as the inner and outer spacers. The manifold faceplates are on-the-order-of three inches thick and have columns of holes across their front sides. The columns of holes on the front face near the left and right edges of the manifold faceplates match the hole pattern of the left and right edges of the outer spacer. The interior columns of holes on the front face of the manifold faceplates match the hole pattern on the left and right edges of the inner spacer. The manifold covers are on-the-order-of two inches thick and have an on-the-order-of one-and-one-half-inch recessed flat area on their front side that leaves on-the-order-of a one-inch solid border. The manifold covers have holes around their perimeters on their front sides that match the size and locations of the holes around the perimeters on the front side of the manifold faceplates.

The electrodialysis stack is assembled as follows. The lower edge of the anode assembly is set on the floor with its front side containing the anion ion exchange membrane facing forward. Next a concentrate water assembly with its lower edge on the floor and with its anion ion exchange membrane facing forward is stacked in front of the anode assembly while leaving a designated space between the anode assembly and the concentrate water assembly. Then a series of concentrate water assemblies with their lower edges on the floor and with their anion ion exchange membranes facing forward are then stacked one-after-the-other from back-to-front after the first concentrate water assembly while leaving a designated space between them. Finally, a cathode assembly with its lower edge on the floor and with its electrode cover facing forward is stacked next to the last concentrate water assembly in the previous stack of concentrate water assemblies while leaving a designated space between them. Then this subassembly is sandwiched between the two manifold faceplates by pressing the front faces of the manifold faceplates against the left and right edges respectively of the anode assembly, concentrate water assemblies, and cathode assembly just stacked together from back-to-front. Screws are placed in all holes made for screws on the front side of the manifold faceplates except for those holes around its perimeter. Then these screws are screwed into the edges of the concentrate water assemblies and anode assembly. Finally, the manifold covers are placed over the manifold faceplates, screws are inserted into all holes around their perimeters on their back sides, through the holes in the manifold faceplates, and then the screws are screwed into the edges of the anode assembly, concentrate water assemblies, and cathode assembly. Of special note, there are open spaces creating naturally occurring vertical holes between the fronts and backs of the anode, cathode, and concentrate water assemblies. These operations complete the construction of the electrodialysis stack.

The entire electrodialysis stack is set on a ledge, which is inside a dilute water reservoir. This ledge does not cover the naturally occurring vertical holes in the electrodialysis stack, but does hold the electrodialysis stack at least a few inches above the floor of the dilute water reservoir. Tubing connects the input and output concentrate water manifolds, pump, and concentrate water reservoir so that concentrate water can be circulated through the electrodialysis unit. Tubing connects the electrolysis water inputs and outputs of the anode and cathode assemblies, pumps, and an electrolysis water reservoir so that electrolysis water can be circulated through the anode and cathode assemblies of the assembled electrodialysis unit. The dilute water reservoir is filled with dilute water while making sure the electrodialysis stack is completely submerged in the dilute water. Consequently, the dilute water below the electrodialysis stack is separated from the dilute water above the electrodialysis stack except for the dilute water filling the naturally occurring vertical holes within the electrodialysis stack. A pump is used to circulate the dilute water from the bottom region of the dilute water reservoir to a place above the dilute water filling the dilute water reservoir where it then falls through the air into the dilute water in the dilute water reservoir. Finally, the dilute water falls through the naturally occurring holes in the electrodialysis stack back to the bottom of the dilute water reservoir. Periodically, the electrodialysis process is interrupted and the concentrate water, that is supersaturated, but below the salt concentration levels where spontaneous precipitation would occur, is emptied into a precipitation tank and saturated water in the precipitation tank is sent back to the concentrate water reservoir where the electrodialysis process resumes operation. A DC power supply is connected to waterproof terminals of the electrode assemblies.

A successfully tested procedure for bonding the ion exchange membranes to the inner and outer spacers is provided. The bonding technique relied on using double-sided adhesive sheet tapes and the process used.

This invention is used in conjunction with reverse osmosis to provide Zero Liquid Discharge ZLD desalination of saline water of moderate salt concentrations, which are typically in the range of 500 to 10,000 parts per million. The process uses a series of reverse osmosis units where the next reverse osmosis unit in the series operates on the waste water from the previous reverse osmosis unit with one exception and the product water from each reverse osmosis unit is combined to form the final product water. The invention operates on the last reverse osmosis unit's waste water. However, the last reverse osmosis unit input water is formed from the waste water from the next to last reverse osmosis unit plus the invention's dilute water from the previous invention's operation that has been reduced in salt concentration to the level of the waste water from the next-to-last reverse osmosis unit. Furthermore, the invention operates on a small amount of concentrate water on-the-order-of five-to-ten gallons until it is supersaturated but below the salt concentration levels where spontaneous precipitation would occur. Every hour or so, the process is interrupted and the concentrate water is sent to a large precipitation tank of saturated saltwater, the large precipitation tank's saturated water is brought back to the invention to become the concentrate water, and the desalination process resumes. There is enough time for the supersaturated salt water sent to the large precipitation tank containing supersaturated salt water to precipitate out solids and become only saturated before being reused as the invention's concentrate water again.

### BRIEF DESCRIPTION OF THE SEVERAL VIEWS OF THE DRAWING(S)

FIG. 1: Schematic illustration of how an ordinary electrodialysis system operates

FIG. 2: Isometric drawing showing the front, top, and left edge of the inner spacer

FIG. 3: Isometric drawing showing the front, top, and left edge of the anion ion exchange membrane

FIG. 4: Isometric drawing showing the front, top, and left edge of the cation ion exchange membrane

FIG. 5: Isometric drawing showing the front, top, and left edge of the retainer sheet

FIG. 6: Exploded isometric drawing showing the fronts, tops, and left edges of the concentrate water assembly containing a retainer sheet, anion ion exchange membrane, inner spacer, cation ion exchange membrane, and another retainer sheet

FIG. 7: Assembled isometric drawing showing the fronts, tops, and left edges of the concentrate water assembly containing a retainer sheet, anion ion exchange membrane, inner spacer, cation ion exchange membrane, and another retainer sheet

FIG. 8: Assembled isometric drawing showing the backs, tops, and right edges of the concentrate water assembly containing a retainer sheet, cation ion exchange membrane, inner spacer, anion ion exchange membrane, and another retainer sheet

FIG. 9: Isometric drawing showing the front, top, and left edge of the outer spacer

FIG. 10: Isometric drawing showing the front, top, and left edges of the electrode cover and electrode

FIG. 11: Isometric drawing showing the back, top, and right edges of the electrode cover, electrode, electrolysis water fittings, and electrode connector

FIG. 12: Exploded isometric drawing showing the fronts, tops, and left edges of the cathode assembly containing an electrode cover and electrode, outer spacer, cation ion exchange membrane, and a retainer sheet

FIG. 13. Assembled isometric drawing showing the fronts, tops, and left edges of the cathode assembly containing an electrode cover and electrode, outer spacer, cation ion exchange membrane, and a retainer sheet

FIG. 14: Assembled isometric drawing showing the backs, tops, and right edges of the cathode assembly containing an electrode cover and electrode, electrolysis water fittings, and electrode connector, outer spacer, cation ion exchange membrane, and a retainer sheet

FIG. 15: Exploded isometric drawing showing the fronts, tops, and left edges of the anode assembly containing an electrode cover and electrode, outer spacer, retainer sheet, cation ion exchange membrane, inner spacer, anion ion exchange membrane, and a retainer sheet

FIG. 16: Assembled isometric drawing showing the fronts, tops, and left edges of the anode assembly containing an electrode cover and electrode, outer spacer, retainer sheet, cation ion exchange membrane, inner spacer, anion ion exchange membrane, and a retainer sheet

FIG. 17: Assembled isometric drawing showing the backs, tops, and right edges of the anode assembly containing an electrode cover and electrode, electrolysis water fittings, and electrode connector, outer spacer, retainer sheet, cation ion exchange membrane, inner spacer, anion ion exchange membrane, and a retainer sheet

FIG. 18: Isometric drawing showing the front, top, and left side of the manifold faceplate

FIG. 19: Exploded isometric drawing showing the fronts, tops, and left sides of the manifold assembly containing a manifold faceplate and a manifold cover on the left

FIG. 20: Exploded isometric drawing showing the fronts, tops, and left sides of the manifold assembly containing a manifold faceplate and a manifold cover on the right

FIG. 21: Exploded isometric drawing showing the fronts, tops, and left sides of the assembly of a manifold faceplate on the left with the cathode assembly, three concentrate water assemblies, and anode assembly

FIG. 22: Exploded isometric drawing showing the fronts, tops, and left sides of the assembly of a manifold faceplate on the right with the cathode assembly, three concentrate water assemblies, and anode assembly

FIG. 23: Assembled isometric drawing showing the fronts, tops, and left sides of the interim assembly containing a cathode assembly, three concentrate water assemblies, anode assembly, and manifold faceplates on the left and on right

FIG. 24: Assembled isometric drawing showing the fronts, tops, and left sides of this inventions electrodialysis stack containing a cathode assembly, three concentrate water assemblies, anode assembly, and manifold faceplates on the left and on the right followed by manifold covers on the left and the right respectively

FIG. 25: Isometric drawing of the dilute water reservoir with the front and left side missing so one can see inside it

FIG. 26: Isometric drawing of the dilute water reservoir with the front and left side missing so one can see inside it but now with the inventions electrodialysis stack setting inside it on the ledge

FIG. 27: Block diagram showing the flow of the dilute and concentrate water

FIG. 28: Block diagram showing how this invention and reverse osmosis are used together to provide desalination with a ZLD property

FIG. 29: Circuit diagram representing the resistances in the invention's electrodialysis stack which includes the concentrate water distribution system but does not include the dilute and electrolysis water distribution systems

### DETAILED DESCRIPTION OF THE INVENTION

### Brief Review of Ordinary Electrodialysis Operation

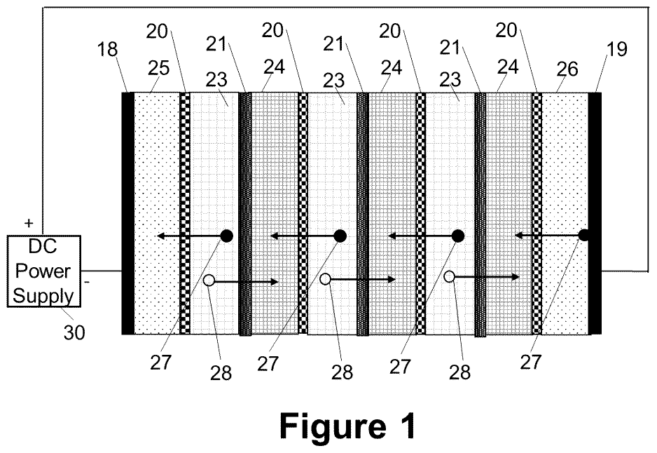

This invention uses all the basic concepts of electrodialysis, but differs in its construction from that of ordinary electrodialysis systems. With the aid of FIG. 1, the basic operation of an electrodialysis system is briefly reviewed. In the interior of an electrodialysis system, there are alternating dilute and concentrate water spaces 23 and 24 separated by alternating cation and anion ion exchange membranes 20 and 21 respectively. At the left end, there is electrolysis water 25 followed by an electrode 18 which becomes the cathode when the electrode 18 is attached to the negative terminal of the DC power supply 30. At the right end, there is electrolysis water 26 followed by an electrode 19 which becomes the anode when the electrode 19 is attached to the positive terminal of the DC power supply 30. An electric field, that is formed between the electrodes 18 and 19, forces cations 27 and anions 28 to move between the electrodes 18 and 19. Cations 27 are driven through the cation ion exchange membranes 20 toward the cathode 18, but they cannot pass through the anion ion exchange membranes 21. Anions 28 are driven through the anion ion exchange membranes 21 toward the anode 19, but they cannot pass through the cation ion exchange membranes 20. In this way, the cations 27 and anions 28 are driven out of the dilute water spaces 23 into the concentrate water spaces 24. However, this process is interrupted at each end at the electrodes 18 and 19 and adjoining electrolysis waters 25 and 26. With the transfer of electrons, Hydrogen gas is formed at the cathode 18 and its adjacent electrolysis water 25 becomes more basic in pH and Oxygen gas is formed at the anode 19 and its adjacent electrolysis water 26 becomes more acidic in pH given an ordinary selection of electrolysis water.

### Brief Overview

This invention is described in terms of a prototype sized electrodialysis unit. Both smaller and larger units are possible by scaling their sizes from this prototype unit. Very briefly, the major components of the electrodialysis stack of this invention are: (1) concentrate water assemblies, (2) cathode assembly, (3) anode assembly, (4) manifold assemblies having manifold faceplate and manifold cover subassemblies. The electrodialysis stack is then submerged into a reservoir of dilute water. The dilute water is circulated through the reservoir and the naturally occurring vertical holes in the electrodialysis stack. The concentrate water is circulated through the manifolds, concentrate water assemblies, and an anode assembly that contains in part a concentrate water assembly. The electrolysis water is circulated in a conventional manner through the anode and cathode assemblies.

### Concentrate Water Assemblies

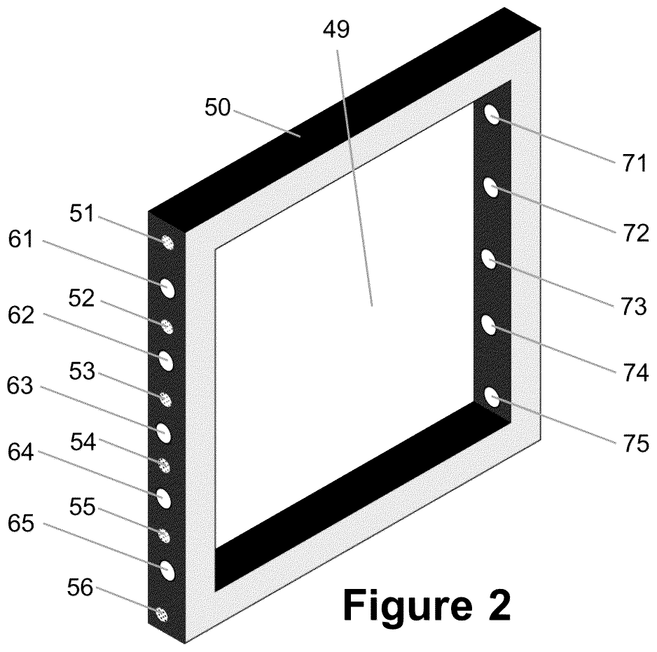

The concentrate water assemblies are composed of a retainer sheet, anion ion exchange membrane, inner spacer, cation ion exchange membrane, and retainer sheet all bonded together. An isometric drawing showing the front, top, and left edge of the inner spacer 50, that is made from plastic, is shown in FIG. 2. For this prototype unit, the inner spacer 50 is twelve inches wide, twelve inches tall, and one inch thick with an empty space 49 in its center that is ten inches on a side. It has one-quarter-inch threaded machine screw holes 51 through 56 on its left edge that are only about three-fourth-inch deep and not completely through the border region of the inner spacer 50.

There are like one-quarter-inch threaded machine screw holes on the right edge of the inner spacer 50, but are hidden from view. There are also one-half-inch holes 61 through 65 that protrude from the outer left edge into the inner spacer's 50 empty space 49. Likewise, there are also one-half-inch holes 71 through 75 that protrude from the outer right edge into the inner spacer's 50 empty space 49. The one-quarter-inch threaded machine screw holes 51 and 56 are near the top and bottom on the left edge respectively. The one-half-inch holes 61 through 65 alternates with the one-quarter-inch threaded machine screw holes 51 through 56 along the left edge and there are like holes on the right edge hidden from view.

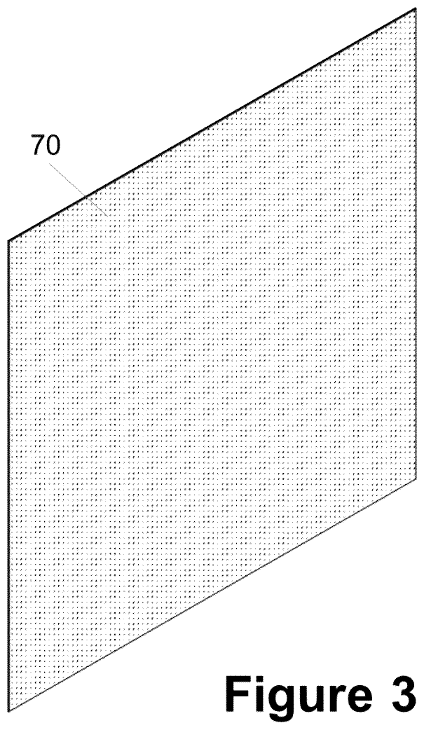

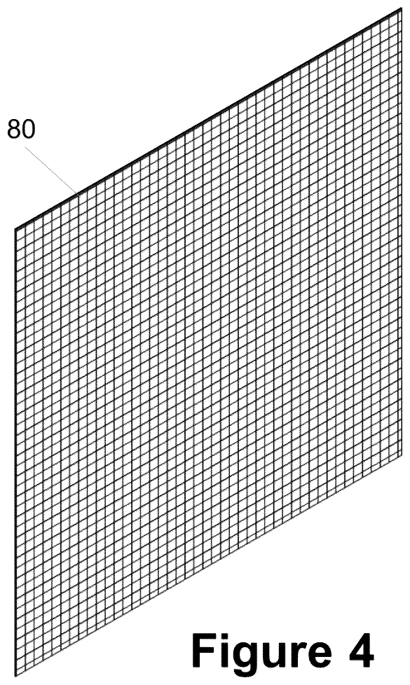

FIGS. 3 and 4 illustrates an isometric drawing showing the front, top, and left edge of the anion and cation ion exchange membranes 70 and 80 respectively. They both have the same width and height of the inner spacer but are only on-the-order-of twenty-mils thick.

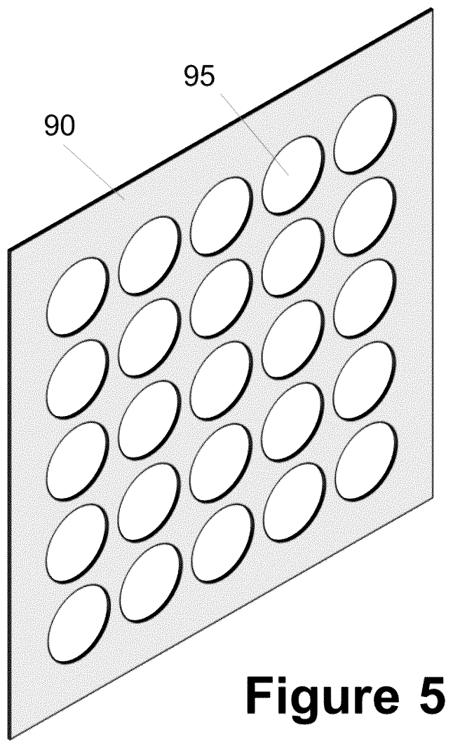

FIG. 5 illustrates an isometric drawing showing the front, top, and left edge of the retainer sheet 90, that is made from plastic. It is same width and height of the inner spacer but only on-the-order-of 30 mils thick. It is covered with holes 95 that are on-the-order-of two-inches in diameter and they are separated by on-the-order-of one-fourth-inch for this example. These holes cover the same area as the empty space in the inner spacer.

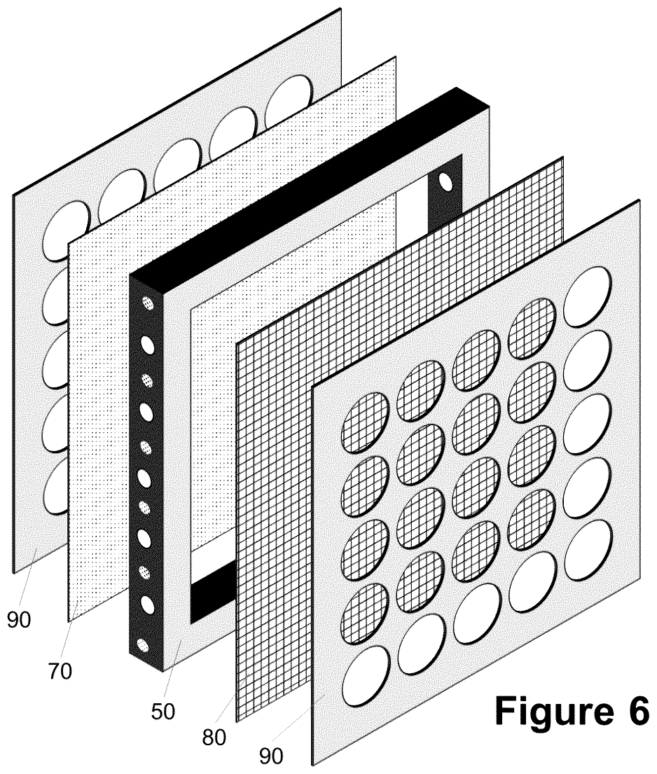

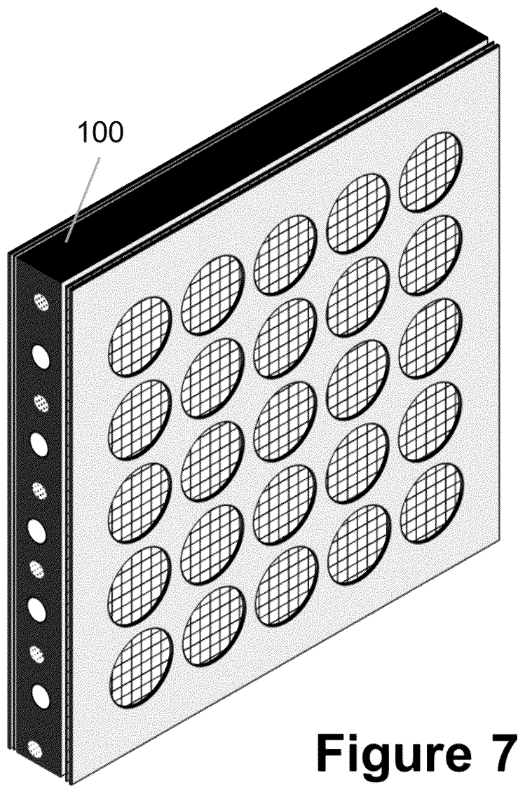

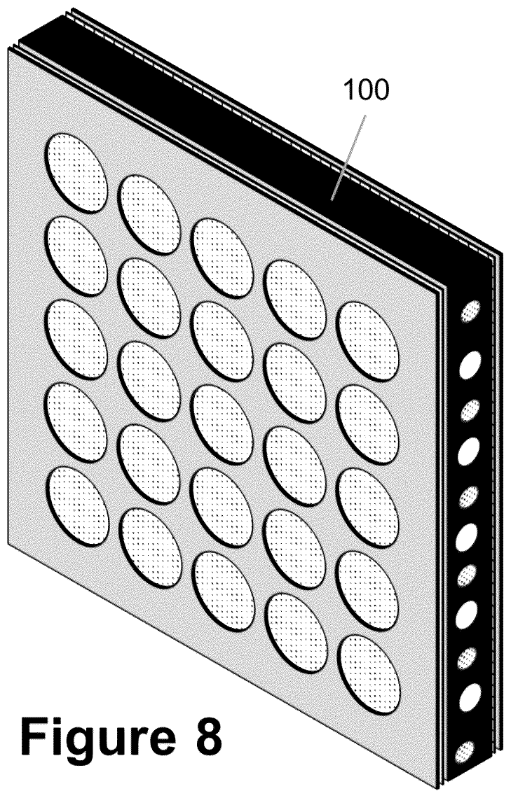

FIG. 6 illustrates an exploded isometric drawing showing the front, top, and left edge of the concentrate water assembly. From left to right it consists of a retainer sheet 90, anion ion exchange membrane 70, inner spacer 50, cation ion exchange membrane 80, and another retainer sheet 90. The assembled components of the concentrate water assembly that are bonded together showing the front, top, and left edge is shown in FIG. 7 and showing the back, top, and right edge in FIG. 8.

### Anode and Cathode Assemblies

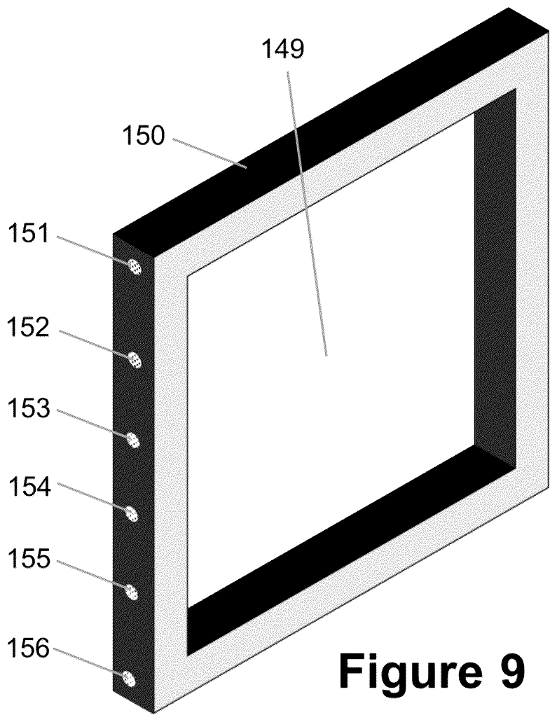

The anode and cathode assemblies are composed of electrode covers, electrodes, outer spacers, inner spacer, anion and cation ion exchange membranes, and retainer sheets. An isometric drawing showing the front, top, and left edge of the outer spacer 150, that is made from plastic, is shown in FIG. 9. For this prototype unit in FIG. 9, the outer spacer 150 is the same width, height, and thickness of the inner spacer with an empty space 149 in its center, which is the same as the inner spacer's empty center. It has one-quarter-inch threaded machine screw holes 151 through 156 on its left edge that are only about three-fourth-inch deep and not completely through the border region of the inner spacer 150. There are like one-quarter-inch threaded machine screw holes on the right edge of the outer spacer 150 but are hidden from view. The one-quarter-inch threaded machine screw holes 151 through 156 are centered in the thickness direction and match the hole patterns of the one-quarter-inch threaded machine screw holes 51 through 56 patterns on the left edge of the inner spacer shown in FIG. 2.

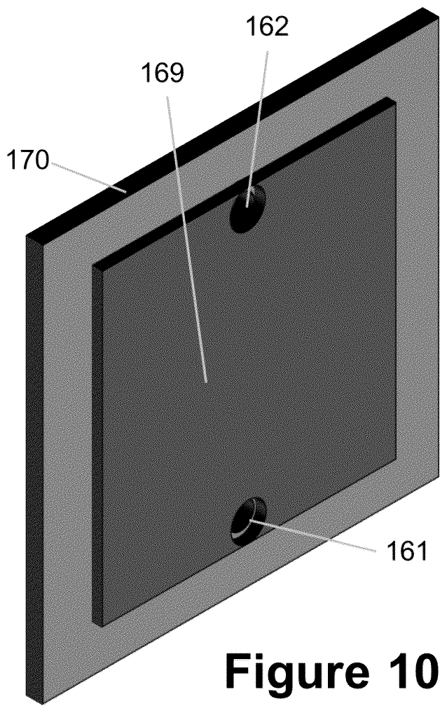

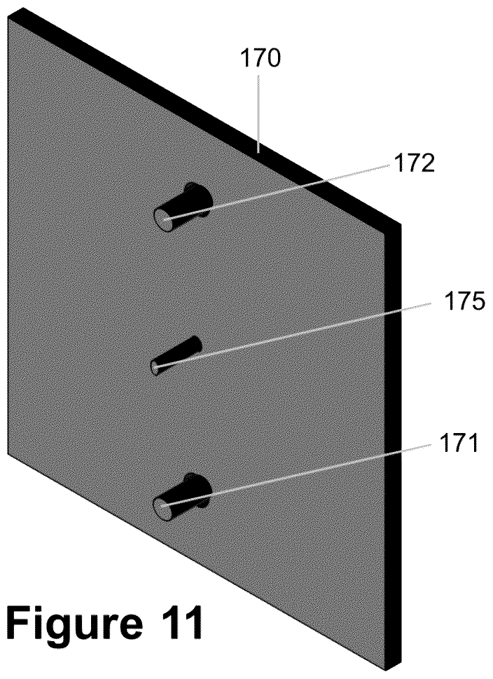

There is an isometric drawing showing the backs, tops, and left edges of an electrode cover 170 with an attached electrode 169 in FIG. 10. There is an isometric drawing showing fronts, tops and right edges of an electrode cover 170 with an attached electrode 169 which now is not visible in FIG. 11. The electrode cover 170, that is made from plastic, is the same width and height as the outer spacer and is on-the-order-of one-fourth-inch thick. In FIG. 10, there is a hole 161 in the lower central region to allow electrolysis water to enter the assembly and there is a hole 162 in the upper central region to allow electrolysis water to leave the assembly. In FIG. 11, there are input and output electrolysis water fittings 171 and 172 respectively, which are used to circulate input and output electrolysis water through the anode or cathode assemblies. There is an electrode connector 175 that is attached to the electrode inside the cover 170.

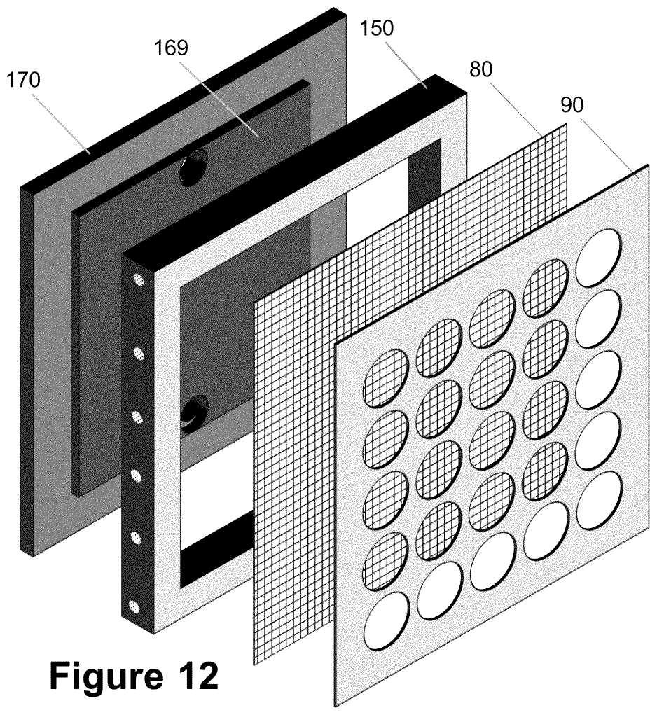

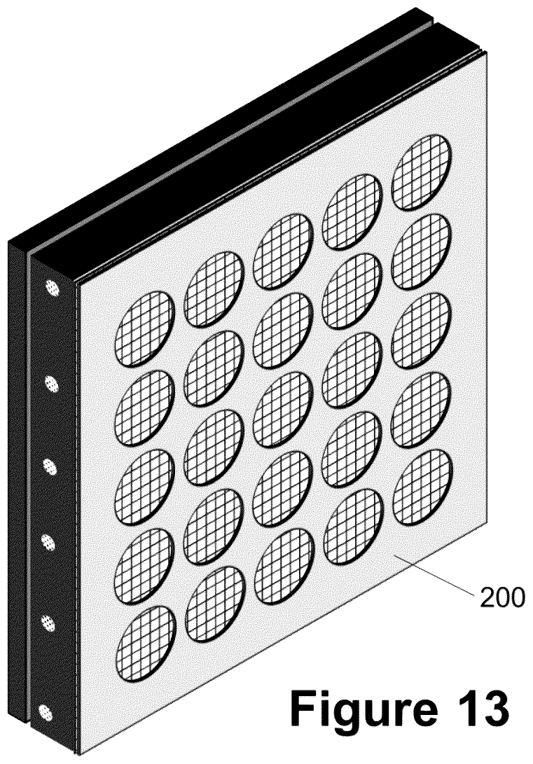

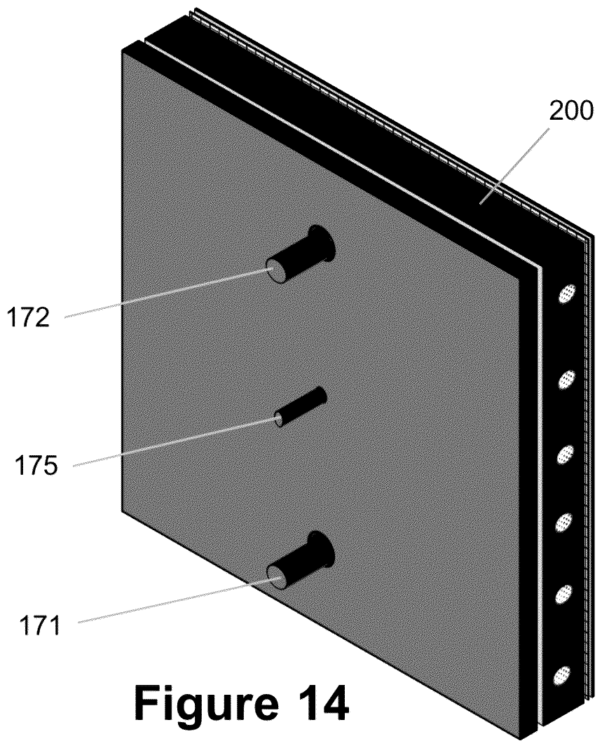

An exploded isometric drawing showing the backs, tops, and left edges of the cathode assembly is shown in FIG. 12. From left to right it contains an electrode cover 170, electrode 169, outer spacer 150, cation ion exchange membrane 80, and retainer sheet 90. The assembled components of the cathode assembly 200, that are bonded together showing the back, top, and left edges, is shown in FIG. 13 and showing the front, top, and right edges in FIG. 14 respectively. In FIG. 14, there are input and output electrolysis water fittings 171 and 172 respectively, which are used to circulate input and output electrolysis water through the cathode assembly. There is an electrode connector 175 that is attached to the electrode inside the cathode assembly 200.

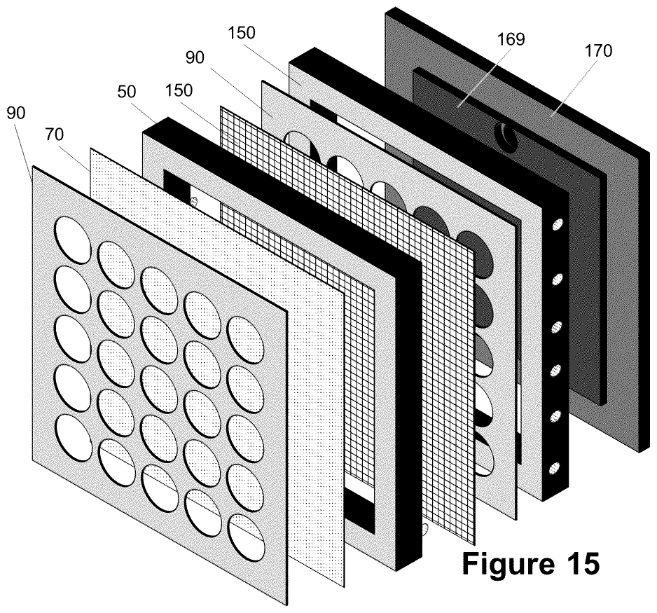

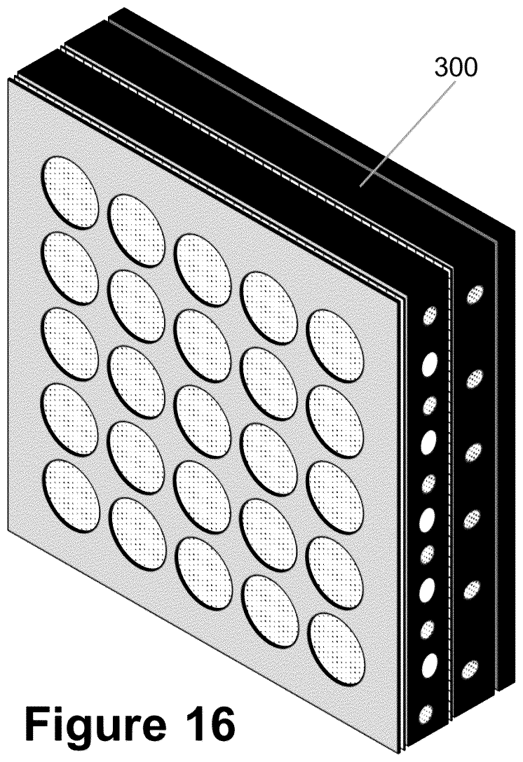

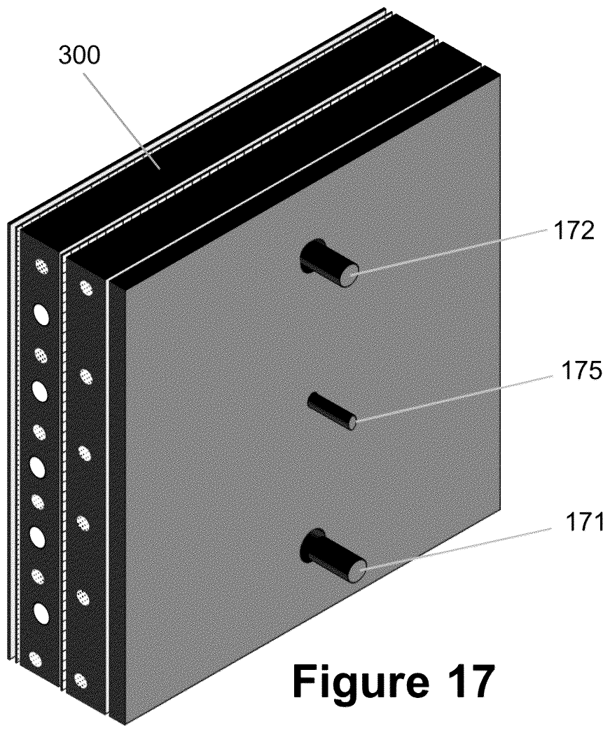

An exploded isometric drawing showing the backs, tops, and right edges of the anode assembly is shown in FIG. 15. From right to left it contains an electrode cover 170, electrode 169, outer spacer 150, retainer sheet 90, cation ion exchange membrane 80, inner spacer 50, anion ion exchange membrane 70, and retainer sheet 90. The assembled components of the anode assembly 300, that are bonded together showing the back, top, and right edges, is shown in FIG. 16 and showing the front, top, and left edges in FIG. 17 respectively. In FIG. 17, there are input and output electrolysis water connectors 171 and 172 respectively, which are used to circulate input and output electrolysis water through the anode assembly. There is an electrode connector 175 that is attached to the electrode inside the anode assembly 300.

### Manifold Assemblies

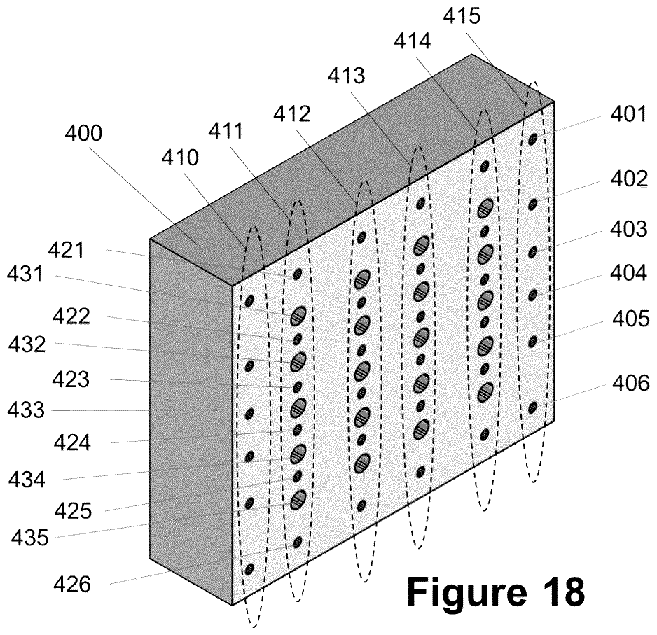

The manifold assemblies, that will distribute-and-retrieve concentrate water to-and-from the concentrate assemblies, are composed of a manifold faceplate and manifold cover, which are both made from plastic. There is an isometric drawing showing the front, top and left side of a manifold faceplate 400 in FIG. 18. There are columns of holes that are encircled with a dotted line 410 through 415. The columns of holes 410 and 415 contain holes 401 through 406 that will pass a one-quarter-inch machine screw them. The locations of the holes 401 through 406 in FIG. 18 match the hole locations 151 through 156 of the outer spacer shown in FIG. 9 in the height direction. The hole locations on the front side from the edge of the manifold faceplate on the left and right in the width direction is the distance of the thickness of the electrode cover plus half the thickness of the outer spacer. The columns of holes that are encircled with a dotted line 411 through 414 have two types of holes. One type of hole 421 through 426 are holes that will pass a one-quarter-inch machine screw through them. The other type of hole are simple holes 431 through 435 in FIG. 18 that are the same diameter and at the same locations in the height direction as the holes 61 through 65 and holes 71 through 75 on the left and right edges of the inner spacer shown in FIG. 2. The locations in the width direction are such that when the left or right edges of the anode assembly, cathode assembly, and concentrate water assemblies are placed against the front side of the manifold faceplate 400, there is to be a designated distance between each assembly which will be discussed in detail later.

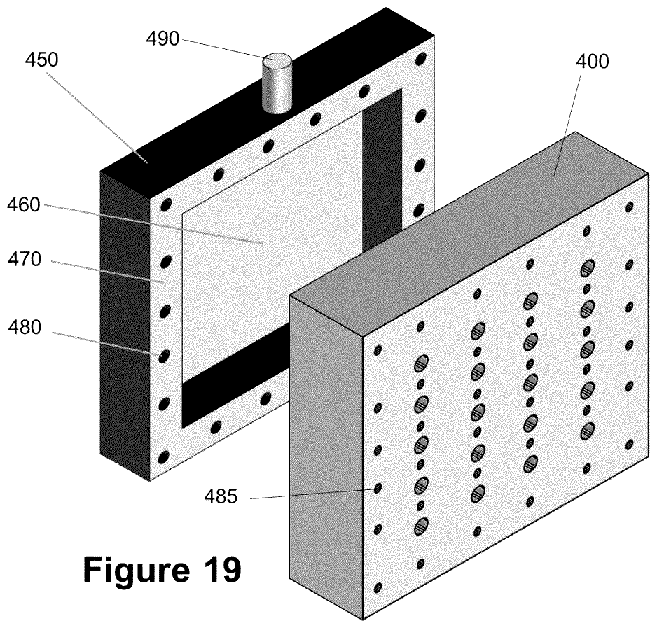

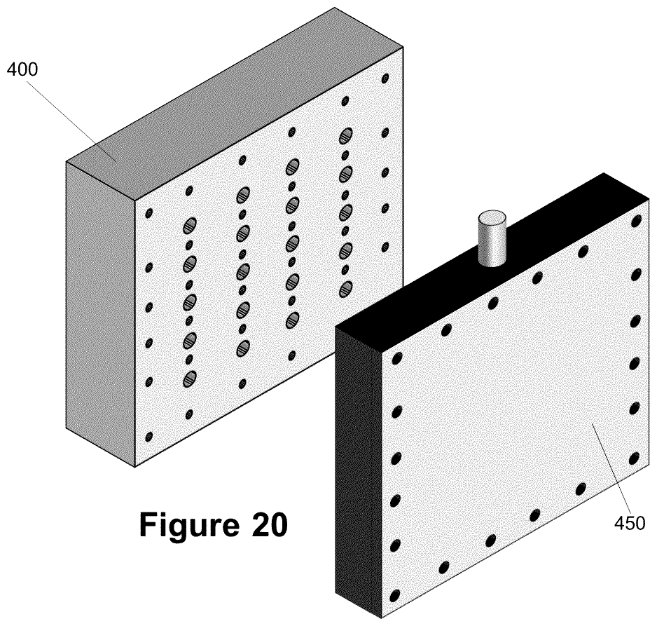

An exploded isometric drawing showing the backs, tops, and left sides of the manifold assembly containing a manifold faceplate 400 and a manifold cover 450 on the left is shown in FIG. 19. The manifold cover 450 has the same width and height as the manifold plate 400 and is on-the-order-of two-inch thick. It has a recessed area 460 that leaves a border 470 that is one-inch on the top and bottom and one-and-one-fourth-inch on the left and right for this prototype unit. There are holes 480 that will pass one-quarter inch machine screw through them. These hole locations 480 are such that when the manifold faceplate 400 and the manifold cover 450 are brought together, the holes 485 in the manifold faceplate 400 that pass one-quarter-inch machine screws through them will be at the hole locations 480 on the manifold cover 450 such that a one-quarter-inch machine screw will consecutively pass through each one. A concentrate water fitting 490, that will pass concentrate water between the outside and the inside of the manifold assembly, is shown in Figure19. An exploded isometric drawing showing the fronts, tops, and left sides of the manifold assembly containing a manifold faceplate 400 and a manifold cover 450 on the right is shown in FIG. 20.

### Assembly of Electrodialysis Stack

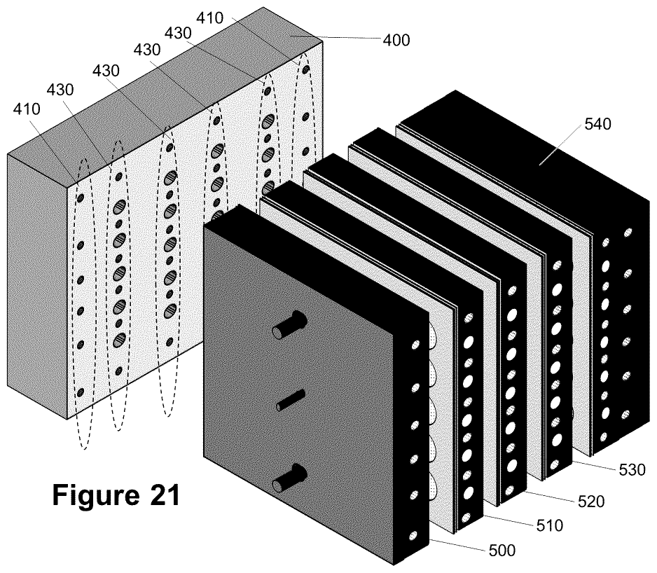

While standing on their bottom edge, the left edges of each of the assemblies consisting of cathode assembly 500, concentrate water assemblies 510, 520, 530, and anode assembly 540 are brought against the front side manifold faceplate 400 standing on its bottom edge as shown in FIG. 21. There will be a gasket, that contains holes to match the hole pattern on the front side of the manifold faceplate, pressed against the front side of the manifold faceplate 400, but is not shown. The column of holes 410 in the manifold faceplate 400, that will pass one-quarter-inch machine screws through them are lined up with the holes that are threaded for one-quarter-inch machine screws in the cathode and anode assemblies 500 and 540 respectively as previously discussed when the cathode and anode assemblies 500 and 540 respectively were described. The column of holes 430 in the manifold faceplate 400, that will pass one-quarter-inch machine screws through them and as well as the one-half-inch holes are lined up with the holes that are threaded for one-quarter-inch machine screws and the one-half-inch holes in the concentrate water and anode assemblies 510, 520, 530, and 540 respectively as previously discussed when the concentrate water and anode assemblies 510, 520, 530, and 540 respectively were described. Except for all the holes surrounding the perimeter of the manifold faceplate 400, one-quarter-inch machine screws will be inserted into the holes that will pass one-quarter-inch machine screws on the back side of the manifold faceplate 400 and screwed into the threaded one-quarter-inch holes on the left edges, that are not shown, of the cathode, concentrate water, and anode assemblies 500, 510, 520, 530, and 540 respectively. These one-quarter-inch machine screws are not shown.

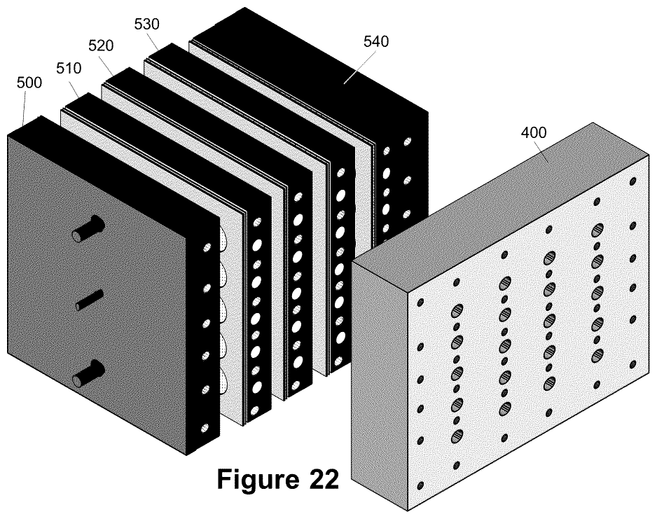

While standing on their bottom edge, the right edge of each of the assemblies consisting of cathode assembly 500, concentrate water assemblies 510, 520, 530, and anode assembly 540 are brought against the back side of another manifold faceplate 400 standing on its bottom edge as shown in FIG. 22. There will be a gasket, that contains holes to match the hole pattern on the back side of the manifold faceplate, pressed against the back side of the manifold faceplate 400, but is not shown. All the holes on the back side of the manifold faceplate 400 are aligned with the like holes on the right edges of the cathode assembly 500, concentrate water assemblies 510, 520, 530, and anode assembly 540 in same manner as was done on assembling the first manifold faceplate's front side with the left edges of the cathode assembly 500, concentrate water assemblies 510, 520, 530, and anode assembly 540. Except for all the holes surrounding the perimeter of the manifold faceplate 400, one-quarter-inch machine screws will be inserted into the holes that will pass one-quarter-inch machine screws on the front side of the manifold faceplate 400 and screwed into the threaded one-quarter-inch holes on the right edges of the concentrate water and anode assemblies 510, 520, 530, and 540 respectively. These one-quarter-inch machine screws are not shown.

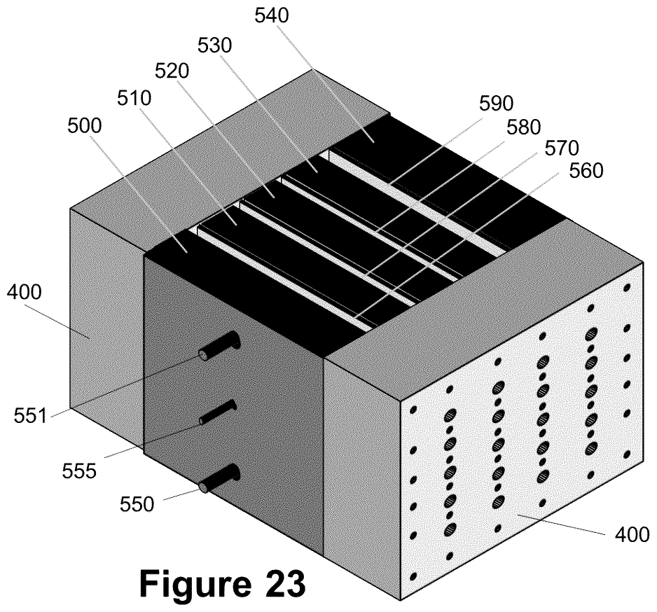

The assembled manifold faceplates 400, cathode assembly 500, concentrate water assemblies 510, 520, 530, and anode assembly 540 is shown in FIG. 23. The cathode assembly 500, concentrate water assemblies 510, 520, and 530, and the anode assembly 540 are sandwiched on both sides by the manifold faceplates 400. There will be open spaces 560, 570, 580, and 590 between the cathode assembly 500, concentrate water assemblies 510, 520, 530, and anode assembly 540. The designated width of these open spaces 560, 570, 580, and 590, later referred to as naturally occurring holes, is the desired spacing between membranes plus twice the distance the ion exchange membrane protrudes outward when the concentrate water pressure exceeds the dilute water pressure which is discussed more later. The inlet and outlet electrolysis water fittings 550 and 551 for the cathode assembly are shown while the like fittings for the anode assembly cannot be seen. The electrode connector 555 for the cathode is shown in the center of the cathode assembly 500 while the like electrode connector for the anode assembly cannot be seen.

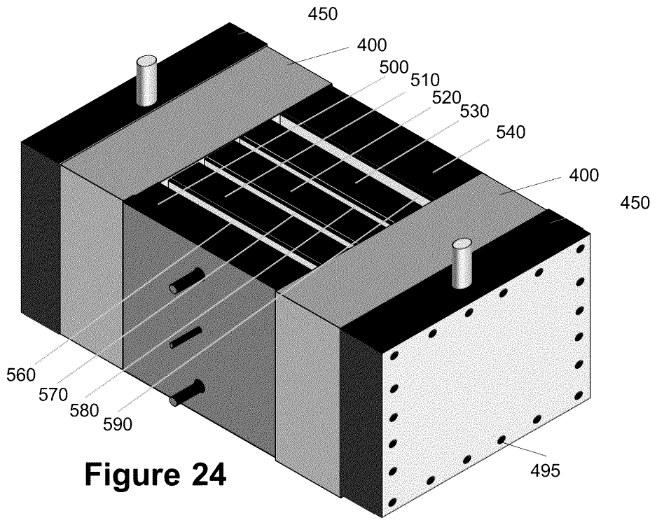

The invention's electrodialysis stack consists of cathode assembly 500, concentrate water assemblies 510, 520, 530, and anode assembly 540, manifold faceplates 400, and the manifold covers 450. The manifold covers 450 sandwich the manifold faceplates 400, which have the cathode assembly 500, concentrate water assemblies 510, 520, 530, and anode assembly 540 assembled between them as shown in FIG. 24. One-quarter-inch screws, that are not shown, are inserted into the holes around the perimeters of the manifold covers 450, through the manifold faceplates, and screwed into the cathode assembly 500, concentrate water assemblies 510, 520, 530, and anode assembly 540. There will be open spaces 560, 570, 580, and 590 between the cathode assembly 500, concentrate water assemblies 510, 520, 530, and anode assembly 540. The designated width of these open spaces 560, 570, 580, and 590, which are referred to as naturally occurring holes, is the desired distance between membranes plus twice the distance the ion exchange membrane protrudes outward when the concentrate water pressure exceeds the dilute water pressure which is discussed more later. The inlet and outlet electrolysis water fittings 550 and 551 for the cathode assembly are shown while the like fittings for the anode assembly cannot be seen. The electrode connector 555 for the cathode is shown in the center of the cathode assembly 500 while the like electrode connector for the anode assembly cannot be seen. This assembly is called the electrodialysis stack.

### Water Distribution Systems

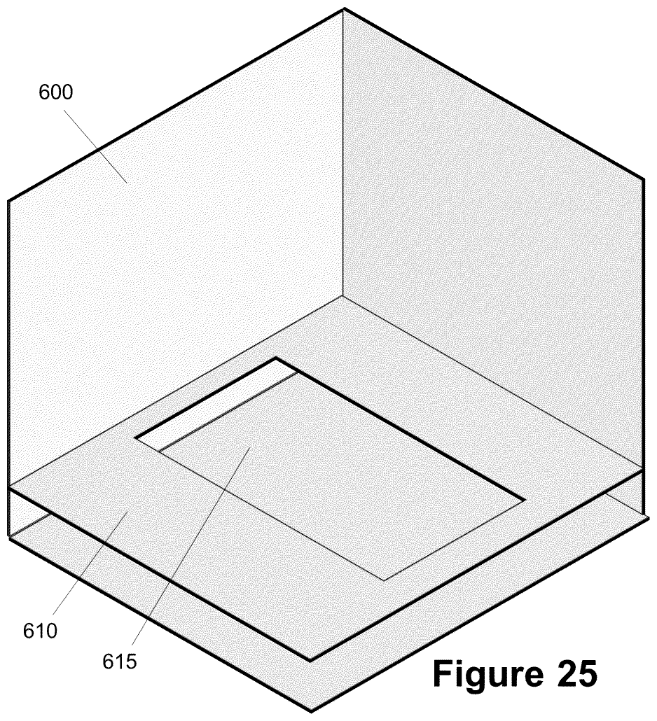

FIG. 25 shows an isometric drawing showing the front, top, and left sides viewed from the front of the dilute water reservoir 600 with the front and left side of the dilute water reservoir 600 removed so one can see inside it. A ledge with a gasket 610 is located around the inside perimeter of the dilute water reservoir 600 and it is located at least a few inches above the dilute water reservoir's 600 floor. This ledge with gasket 610 will be used to support the electrodialysis stack above the floor of the dilute water reservoir 600. There is an opening 615 in the central portion of the ledge where the dilute water will pass through from the top to the bottom. The size of the opening is such that it is at least big enough to not cover the openings 560, 570, 580, and 590 that are between the cathode assembly, concentrate water assemblies, and anode assembly for the electrodialysis stack shown in FIG. 24, but small enough to allow the electrodialysis stack shown in FIG. 24 to rest on the ledge 610. For the prototype unit, the dilute water reservoir's 600 would be ten inches wide, 24 inches long and 24 inches high so the electrodialysis stack shown in FIG. 24 could easily fit completely inside it.

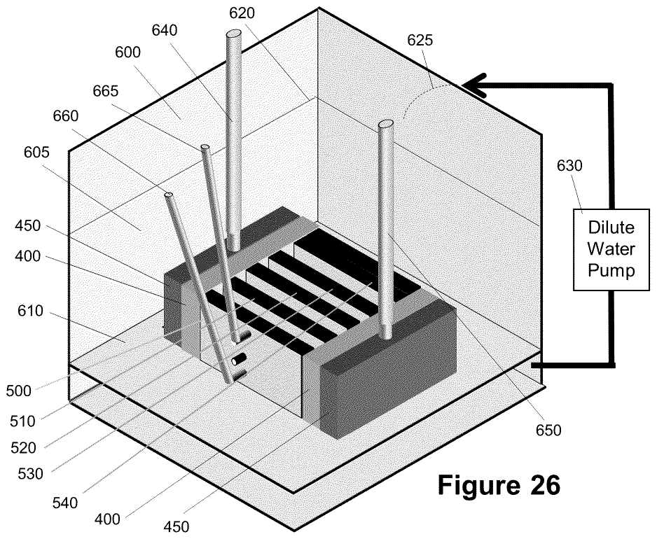

FIG. 26 shows the isometric drawing showing the front, top, and left sides viewed from the front of the dilute water reservoir 600 with the front and left side of the dilute water reservoir 600 removed so one can see inside it as shown in FIG. 25, but now in addition the electrodialysis stack shown in FIG. 24 is setting on the ledge with gasket 610 inside the dilute water reservoir 600. The ledge with gasket 610 supports the electrodialysis stack but does not cover the naturally occurring vertical holes between the cathode assembly 500, concentrate water assemblies 510, 520, 530, and anode assembly 540 in the electrodialysis stack. The dilute water 605 fills the dilute water reservoir 600 to the water line 620. The dilute water below the electrodialysis stack is isolated from the dilute water above it except for the dilute water present in the naturally occurring vertical holes in the electrodialysis stack. The manifold faceplates 400 and manifold covers 450 on both sides of the cathode assembly 500, concentrate water assemblies 510, 520, 530, and anode assembly 540 can also be seen in FIG. 26. There is a dilute water pump 630 that pumps dilute water through hoses from below the ledge 610 to the top of the dilute water reservoir 600 leaving an airgap 625 between the exit hose and the top surface of dilute water in the dilute water reservoir 600. The dilute water then falls from the airgap 625 to the dilute water line 620 in the dilute water reservoir and then through the naturally occurring holes as the dilute water is pumped from the bottom of the dilute water reservoir 600 to its top. This dilute water then flows between a cation and anion exchange membrane in the naturally occurring holes formed from the placement of the cathode assembly 500, concentrate water assemblies 510, 520, 530, and anode assembly 540, which is required for electrodialysis operation. There is an inlet concentrate water hose 640 and an outlet concentrate water hose 650 attached to the manifold covers 450, which are used to circulate concentrate water through the electrodialysis stack. Finally, there is an inlet electrolysis water hose 660 and an outlet electrolysis hose 665 attached to the cathode assembly 500, which are used to circulate electrolysis water through the cathode assembly 500. There are also similar inlet and outlet electrolysis water hoses attached to the anode assembly 540, which are not shown. The electrolysis water reservoir and pump, which are used to circulate the electrolysis water through the cathode and anode assemblies 500, 540, are not shown in FIG. 26.

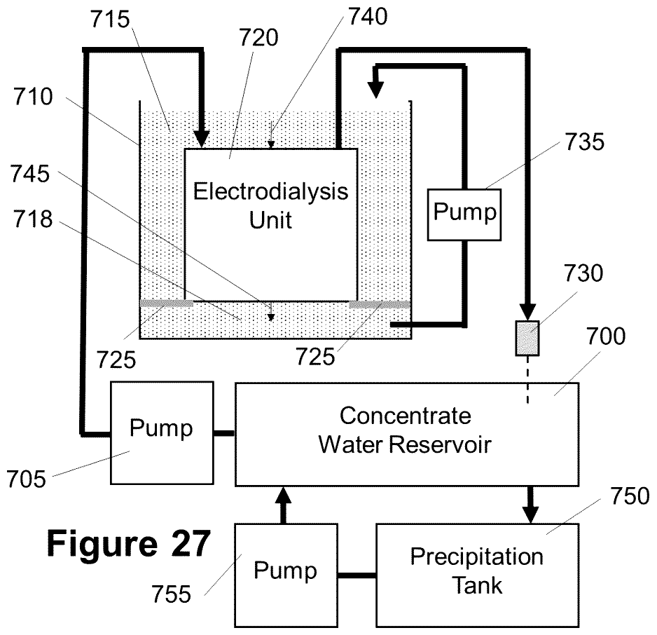

FIG. 27 shows a block diagram of the concentrate and dilute water flows in this invention. The concentrate water flows from the concentrate water reservoir 700 through a pump 705 over the top of the dilute water reservoir 710 holding the dilute water 715 and on to the electrodialysis unit 720. Then the concentrate water flows through the manifold cover, manifold faceplate, cathode assembly, concentrate water assemblies, anode assembly, another manifold faceplate and manifold cover all which are not shown of the electrodialysis unit 720 and out of the electrodialysis unit 720.

From the electrodialysis unit 720, the concentrate water flows over the top of the dilute water reservoir 710, back down to an airgap 730, and then back to the concentrate water reservoir 700.

Again, in FIG. 27 the electrodialysis unit sets on a ledge 725 that is on-the-order-of three inches above the floor of the dilute water reservoir 710. This ledge 725 has an opening in its interior to allow dilute water to pass through it in the region of the naturally occurring holes of the electrodialysis unit 720. The dilute water 718 flows from the bottom of dilute water reservoir 710 through a pump 735 to a place above the dilute water reservoir 710 where it falls into the dilute water 715 in the dilute water reservoir 710. The entry dilute water falls 740 through the naturally occurring holes in the electrodialysis unit 720, that are not shown, and exits at 745 into the dilute water 718 below the electrodialysis unit 720. Finally, the concentrate water in the concentrate water reservoir 700 is briefly circulated for a few minutes through a precipitation tank 750 using a pump 755 every few hours. This gives time for the solids to precipitate out of the slightly supersaturated concentrate water in the precipitation tank 750. The electrolysis water distribution system is not discussed because it is the same as ordinary electrodialysis systems.

### Discussion on Electrical Power Loses in the Water Distribution Systems

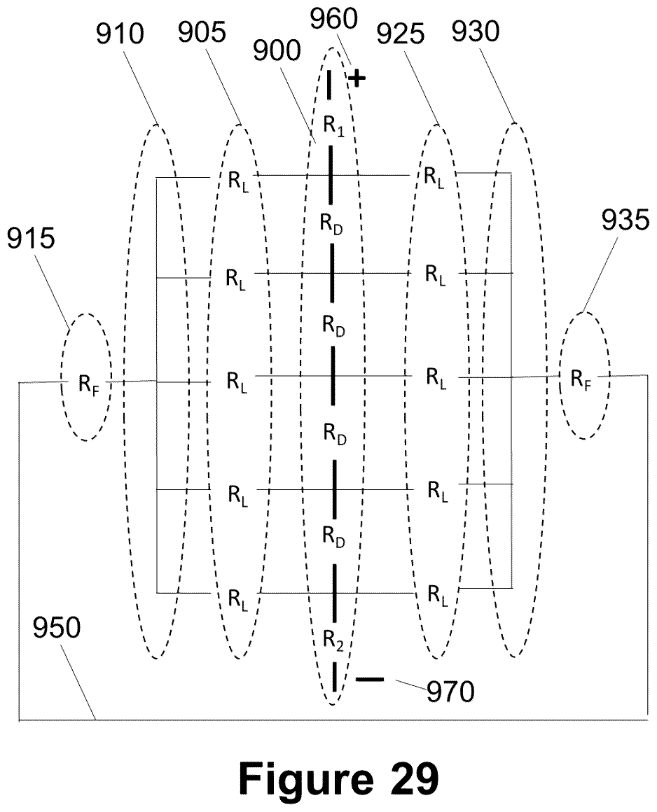

In an electrodialysis system, electrical currents directly flow through the ion exchange membranes and the dilute and concentrate water between them as well as there can be leakage currents flow through the dilute and concentrate water distribution systems. In FIG. 29, a resistance network is formed to model the resistance in the direct path for current flow through the ion exchange membranes and dilute and concentrate waters and the resistances in the current leakage paths in the concentrate water distribution system. The dilute and electrolysis water distribution systems are not shown nor analyzed in the following analysis. In this analysis, the concentrate water is assumed supersaturated and thus has a very high conductivity. Because of the concentrate water high conductivity and the geometry of some of the paths in the electrodialysis unit, the resistance through the concentrate water space between ion exchange membranes is modeled as zero and the resistance through the common water portion of the manifolds is modeled as zero as well. Observing FIG. 29, the direct path for current that provides desalination is shown encircled by a dotted line 900. The direct path 900 has an initial resistance R₁ from the positive terminal 960 of a power supply to the first concentrate water space. There the path diverges through the anion and cation membranes plus the dilute water space to the next concentrate water space which has a total resistance of R_{D} and the individual paths in the feed and retrieve manifolds having a resistance of R_{L}. The feed and retrieve manifolds are composed of individual concentrate water paths 905 and 925 respectively and the common concentrate water portions 910 and 930 respectively. Note there is no appreciable resistance in the common concentrate water portions 910 and 930 but there is connectivity in the common water paths between the individual concentrate water paths in 905 and 925. This sequence of resistances and electrical connections repeats itself until at the end there is a resistance R₂ between the last concentrate water space and the negative terminal of the power supply 970. There are hoses 915 and 935 connecting the feed and retrieve ports of the common concentrate water portions 910 and 930 of the manifolds to the concentrate water reservoir 950 and the resistance through them is R_{F}. The resistance through the concentrate water reservoir 950 is approximated to be zero. Because these hoses are usually several feet long and of small diameters like one-half inch, their resistance is high. The voltage between the concentrate water in the manifolds at the tubing and manifold interface is about zero. With the high resistance in the tubing and almost zero volts across the input and output of the manifolds, there is approximately no current in the tubing and thus the tubing and concentrate water reservoir need not be considered further in the analysis.

Referring to FIG. 29, the currents and voltages of this resistor network could be found by using Kickoff's law to write a set of linear equations for currents and resistances and then solved. This is beyond the scope of this patent application. However, by inspection one can see if the resistance in the individual paths of the manifolds 905 and 925 are large compared to the resistances through the direct path 900 that performs desalination, that most of the current will flow through the path of least resistance which is through the resistances R_{D} and a smaller amount of current through the current leakage path of higher resistances R_{L}.

Using the electrodialysis unit described in this patent application as an example, the resistances for the resistor model shown in FIG. 29 are calculated. The current flows from a concentrate water space through an ion exchange membrane, through the dilute water, through another ion exchange membrane, and finally into another concentrate water space. The electrical resistance R_{D} to current flow for this path is the sum of the electrical resistance through the two ion exchange membranes plus the electrical resistance through the dilute water. The electrical resistance through the dilute water R_{d} is given by L/(σA) where L is the length of the path, σ is the conductivity of the dilute water, and A is the cross-sectional area of the active region of the ion exchange membrane which is through all the 25 holes of a diameter of two inches of the retainer sheet. The electrical resistance of the ion exchange membranes Rₘ is given by 2α/A where α is the area resistance of the ion exchange membranes and A is the cross-sectional area of the active region of the ion exchange membrane which is through all the 25 holes of a diameter of two inches of the retainer sheet. In our prototype example, A is 78.5 square inches, L is 0.1 inch, σ is 21.4 milli Siemens/in for NaCl solution having a concentration of 4,000 ppm, and α is 4.65-ohm inches squared. So, the electrical resistance of the direct path R_{D} through the ion exchange membrane, through the dilute water, through another ion exchange membrane, and finally into another concentrate water space is given by 0.18 ohms for this invention's example. In this case the electrical resistance of the ion exchange membranes is larger than the electrical resistance of the dilute water space.

The electrical resistance from the concentrate water space to the common concentrate water in the manifold cover which is the first part of the concentrate water distribution system is given by R_{L} equal to L/(σN A) where L is the length of the path through the manifold faceplate plus the width of the borders in the concentrate water assemblies, σ is the conductivity of the concentrate water, A is the cross-sectional areas of the holes through the manifold faceplate and the borders in the concentrate water assemblies. In this case L is 4 inches, σ is 1725 milli Siemens/in for the worst case of the NaCl solution being saturated, A is 0.08 square inches squared for the one-half-inch holes, and N is 5 holes of a diameter of one-half-inch. So, the electrical resistance of an individual path through the manifold of the concentrate water distribution system R_{L} for this example is equal to 2.3 ohms. So, the electrical resistance of the first part of the concentrate water distribution path R_{L} is 13 times larger than the resistance through the direct path R_{D} through the electrodialysis stack from one concentrate water space to the next concentrate water space for this invention and example. So, the result is that by choosing the cross-sectional area and path length of the individual paths in the manifold, one can make the currents and associated power loss low in the concentrate water distribution system relative to the currents and power loss in the direct path that perform desalination for a set of parameters of the electrodialysis unit even when the concentrate water is supersaturated but below salt concentration levels where spontaneous precipitation would occur. A similar analysis of the dilute water distribution systems shows that their power losses are even much lower than any losses in the concentrate water distribution system.

### Bonding Procedures

Several non-inclusive bonding procedures are given based on the construction of some test fixtures which were successfully tested. The test fixtures were limited to bonding procedures based on double-sided adhesive sheet tapes. Although glues, epoxies, and cements might be good candidates for study and bonding, they are not discussed here mainly because they are messy in that one needs to remove the excess adhesive as the objects being bonded are brought together and one needs to wait for hours for these adhesives to dry while the objects being bonded are continually pressed tightly together.

Neither was pressure sensitive spray adhesives used although they may be good alternatives or complements to the double-sided adhesive sheet tapes. No doubt there is quite a number of successful bonding procedures, only a few are discussed in this invention.

To represent an inner or outer spacer, a test block was constructed using a four-inch square block of expanded PVC material, that was one-inch thick, had a two-inch hole in its center, and holes on opposite edges where tube water fittings were inserted. The cation and anion ion exchange membranes, which had part numbers AMI 7000 and CMI 7001 respectively, were purchased from Membranes International located in Ringwood, NJ. The double-sided adhesive sheet tapes were manufactured by 3M Corporation in Saint Paul, MN. The double-sided adhesive sheet tapes have a carrier in their center with pressure sensitive adhesive on each side of the carrier followed by removable liners on their outsides so the adhesives on the tape does not stick to anything until used. Two sheet tapes used in this invention are the 3M VHB double-sided foam adhesive sheet tape 5952 that is 45 mils thick and 5906 that is 6 mils thick where the two tapes vary in adhesive variation, foam thickness, and carrier type. Another one used in this invention is the 3M the 9475LE that is 45 mils thick and has a clear polyester carrier. The 3M tapes 5906 and 9475LE are claimed to have adhesives that are particularly well suited for low energy surfaces such as polypropylene. All the tapes are highly water resistant.

First, there is preparation work to be performed. The surfaces to receive adhesive on the test block are sanded, thoroughly cleaned, wiped with isopoll alcohol, dried, painted with a 3M tape primer, and finally dried which should only take a few minutes. Holes are cut in the double-sided adhesive sheet tape so the sheet tape will only touch the outer flat surfaces of the test block. Finally, the ion exchange membranes are soaked in water for at least 24 hours where they will expand in a little in size.

One of the two protective liners of the double-sided adhesive sheet tape is removed and the tape is then laid down on the floor of a flat surface with its adhesive pointed upward. While matching the surfaces of the test block that will receive adhesives with the surfaces of the double-sided adhesive sheet tape, the test block is carefully placed down and pressed onto the double-sided adhesive sheet tape. The test block with the double-sided sheet tape adhering to it is turned over and a roller is used to further press the double-sided sheet tape against the test block. This process is repeated on the other side of the test block. The placement of the test block onto the double-sided adhesive sheet tape can be improved using a jig, machine, or both.

An anion ion exchange membrane is pulled from the water it was soaking in and the excess water is removed. The surface that will receive adhesive is marked and the remaining surfaces masked off. The anion ion exchange membrane with its masked off surfaces is painted with tape primer, allowed to dry for about several minutes, and the masking is removed. The second protective liner of the double-sided sheet tape that is adhered to the test block is removed. While matching the surfaces of the double-sided adhesive sheet tape adhered to the test block with the surfaces that received tape primer on the anion ion exchange membrane, the double-sided adhesive sheet tape adhered to the test block with its adhesive pointed down is carefully placed down and pressed onto the anion ion exchange membrane laying on a flat horizontal surface with the side that received the tape primer pointed up. This entire assembly consisting of the test block, double-sided sheet tape, and anion ion exchange membrane is then turned over and a roller is used to further press the anion ion exchange membrane against the double-sided adhesive sheet tape, and test block. This process is then repeated on the other side of the test block using the cation ion exchange membrane instead of using the anion exchange membrane.

The test assembly that now has an anion ion exchange membrane bonded to the test block using a double-sided adhesive sheet tape on one side of the test block and a cation ion exchange membrane bonded to the same test block using a double-sided adhesive sheet tape on the other side of the test block is then laid flat on a horizontal floor and a heavy weight is set on it. The weight should be large enough to form a pressure on-the-order-of two pounds per square inch over all the surfaces that are being bonded. This weighted test assembly is left for at least 72 hours, which provides time for the bond to dry and strengthen. An alternative to the weight is; the completed block could be pressed together using a clamp or mechanical press.

Tests were conducted on the test assemblies that used the double-sided adhesive sheet tapes previously discussed. A small sump pump that could reach a pressure of 11 psi under full load and a flow rate of 40 gallons per minute under no load was used. A hose was connected from the sump pump setting in a water reservoir to the test assembly and a hose returned the water from the test assembly to the water reservoir. The test assembly is then set in another water reservoir. The pump was activated and operated intermittently over several days so that any leaks that might occur could be observed. There were no leaks observed for all three test assemblies using the three double-sided adhesive sheet tapes described earlier. However, the ion exchange membranes expanded into a very flattened dome protruding out from the test assembly. In this case the very flattened dome's height was about two-tenth-inch high across most of the flattened dome. This flattened dome shape and height was constant over the days tested. When the pump was turned off, the ion exchange membranes over the region that is empty behind them became a little loose and even sometimes receded a little into the test block. So, if the pressure of the water was higher on the outside of the test assembly, the very flattened dome could protrude inward rather than outward. When the assembled test block was completely dried, the anion and cation ion exchange membranes were stretched very tightly across the hole in the test block and were very flat.

The very flattened domes effect the design of this invention's electrodialysis system. If the very flattened domes protrude outward, the thickness of the dilute water space must be the height the very flattened domes on the anion and cation ion exchange membranes plus the desired dilute water spacing. If the very flattened domes protrude inward, the thickness of the dilute water space must be simply just large enough for water to flow between two concentrate water assemblies, which is on the order of one-tenth-inch. The retainer sheets will minimize the effect of the ion exchange membranes protruding much into the dilute water when the concentrate water pressure exceeds that of the dilute water.

### Application

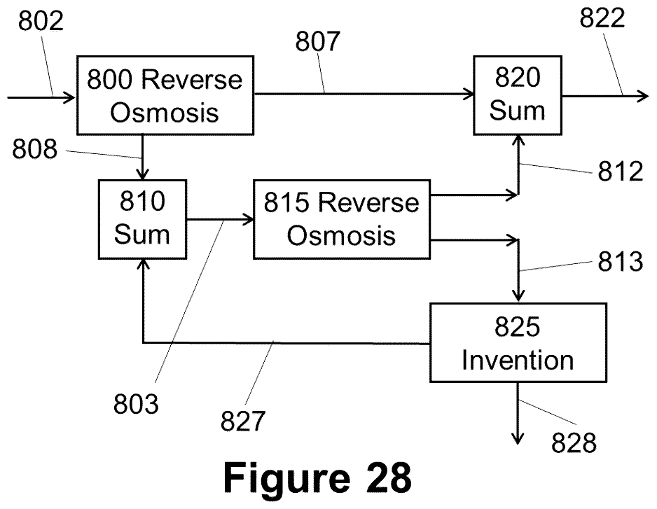

FIG. 28 illustrates an ideal proposed desalination process that provides quality water with a total dissolved solids TDS near zero ppm and only solid salt as a waste. For example, a thousand gallon of feed water having a salt concentration of 3,000 ppm enters the first 50% reverse osmosis unit 800 at 802. Five hundred gallons of water 807, having a salt concentration of 0-ppm, leaves the 50% reverse osmosis unit 800 and travels to the sum function 820. Five hundred gallons of waste water 808 having a salt concentration of 6,000 ppm leaves the 50% reverse osmosis unit 800 and travels to the sum function 810. The sum function 810 combines this waste water 808 from the first 50% reverse osmosis unit 800 having a salt concentration of 6,000 ppm with dilute water left from the operation by this invention's electrodialysis unit on the previous processed dilute water 827, which provides five hundred gallons of salty water having a salt concentration of 6,000 ppm. After these two waters are combined in the sum 810, there is one thousand gallons of water with a salt concentration of 6,000 ppm 803. This combined water 803 from sum 810 is sent through a second 50% reverse osmosis unit 815. One output water 812 from the 50% reverse osmosis unit 815 is five hundred gallons of water having a salt concentration of 0-ppm which is combined with the water 807 with a salt concentration of 0-ppp from the first reverse osmosis unit 800 in the sum 820 to provide one thousand gallons of water 822 with a salt concentration of 0-ppm, which is the same amount of water as the input feed water but without the salt. After the dilute water from the previous invention's process is emptied from this invention's electrodialysis unit 825, the output waste water 813 from the second 50% reverse osmosis unit 815, consisting of five hundred gallons of waste water having a salt concentration of 12,000 ppm, goes to the dilute water of this invention's electrodialysis unit 825. This invention's electrodialysis unit 825 processes this dilute water and outputs 24 lbs. of salt through precipitation and five hundred gallons of water 827 having a salt concentration of 6,000 ppm back to the sum 810. So, the result is the one thousand gallons of input salt water having a concentration of 3,000 ppm has been separated into one thousand gallons of water with no salt and 24 lbs. of solid salt. In volume, there is 134 cubic feet of water without salt and 0.18 cubic feet of solid salt. A similar process was described in Citation 2 in INFORMATION DISCLOSURE STATEMENT BY APPLICANT Form PTO/SB/08a (01-10) under NON-PATENT LITERATURE DOCUMENTS in its FIGS. 43 and 48.

This invention is attractive in two ways: (1) for dilute water with salt concentrations operating below about 10,000 ppm, this invention can remove salt from the dilute water very efficiently even when the concentrate water is supersaturated, and (2) in conjunction with a desalination process such as reverse osmosis it can separate the salt from the input salt water to provide separate quantities of solid salt and water with near zero ppm concentrations, and (3) no liquid waste. Operating on dilute water, the power lost in the electrodialysis process is mainly due to the resistance power lost in the membranes which cannot be avoided and the small amount of power lost in the electrolysis process at the electrodes. When the dilute water has a modest salt concentration on-the-order-of 5,000 ppm, the reverse osmosis process is usually cost effective per thousand gallons processed and the cost of removing the small amount of salt in these waters are also cost effective per thousand gallons processed.

There are very large quantities of moderate salinity water beneath the earth which are not near the ocean. This invention may best be used in an affordable desalination process to provide quality water from this water while only having solid salt waste products. An example is given for desalinating one hundred million gallons of salt water having a salt concentration of 3,000 ppm. Ideally using today's technology, if a fifty percent reverse osmosis process is used to desalinate the water, the result would be fifty million gallons of quality water and fifty million gallons of waste salty water having a salt concentration of 6,000 ppm to dispose of, which would be a formidable task. However, using the process just described using FIG. 28, the process would yield one hundred million gallons of water having 0-ppm salt concentration and 1200 tons of solid salt. If a railroad car holds 80 tons, it would take 15 railroad cars to haul this waste salt away to a ship in port to be disposed in the ocean. This process is thought to be affordable to provide municipal, industrial, and high valve crops farming water when the alternative is not enough water at all.

1. This invention's electrodialysis system externally and simultaneously circulates the dilute water through each dilute water space and the thickness of each dilute water space can be as small as on-the-order-of one-tenth-inch.

2. This invention's electrodialysis system simultaneously distributes-and-retrieves the concentrate water to-and-from each concentrate water space using an external attached manifold and furthermore, by appropriately setting the parameters of path length and cross-sectional area of each individual like path in the manifold for a given set of electrodialysis parameters consisting of concentrate and dilute water space's thicknesses, cross-sectional areas, and salt concentrations and the parameters of the anion and cation ion exchange membranes, the electrical power lost in the concentrate water distribution system can be made lower than the electrical power used for desalination even when the concentrate water is supersaturated, but below the salt concentration levels where spontaneous precipitation would occur.

3. Each concentrate water assembly consists of:
a sequence of a retainer sheet, anion ion exchange membrane, inner spacer, cation ion exchange membrane, and retainer sheet all bonded from back-to-front together,
the retainer sheets, anion and cation exchange membranes, and inner spacer are on-the-order-of one-to-five feet wide and high,
a flat retainer sheet is a flat plastic material on-the-order-of thirty-mils thick, has a solid border on-the-order-of one-inch wide, and is otherwise perforated with one-half-inch to two-inch diameter holes on its front side,
the flat solid anion and cation ion exchange membrane sheets are on-the-order-of twenty-mils thick,
an inner spacer is a flat plastic material and is on-the-order-of one-inch-thick,
looking at an inner spacer's front side, it is empty except for a border on-the-order-of one-inch wide,
an inner spacer has on-the-order-of one-quarter-inch threaded holes along its left and right edges, these holes are on-the-order-of two inches apart, and these holes are not deep enough to penetrate the empty space of the inner spacer's interior, and
an inner spacer also has on-the-order-of one-half-inch plain holes along its left and right edges, these holes are between each threaded hole, and these holes will penetrate the empty space of the inner spacer's interior.

4. The cathode assembly consists of:
a sequence of an electrode cover, electrode, outer spacer, cation ion exchange membrane, and retainer sheet all bonded from back-to-front together,
the outer spacer is the same as the inner spacer of claim 3 except it does not have plain holes on its left and right edges,
the retainer sheets and cation ion exchange membrane are all the same as described in claim 3,
the electrode cover is the same width and height as the outer spacer, is on-the-order-of one-fourth-inch thick, and is made from plastic,
the electrode cover has holes near the bottom and top of the front view, that contain water fittings for the purpose of circulating electrolysis water through the cathode assembly,
an electrode has the same width and height as the empty space of the outer spacer, has a thickness on the-order-of one-eighth-inch, and is mounted on the electrode covers inside face, and
an electrode connector passes through the electrode cover, attaches to the electrode, and is water tight.

5. The anode assembly consists of:
a sequence of an electrode cover, electrode, outer spacer, retainer sheet, cation ion exchange membrane, inner spacer, anion ion exchange membrane, and retainer sheet, all bonded from front-to-back together, and
the retainer sheets, anion and cation ion exchange membranes, outer spacer, inner spacer, electrode, and electrode cover with its water fittings and electrode connector are all the same as described in either claim 3 or claim 4.

6. Each manifold consists of:
a manifold faceplate and manifold cover along with a gasket placed between them,
a manifold faceplate and a manifold cover are made from plastic and are the same height as the inner and outer spacers of claims 3 and 4,
a manifold faceplate and a manifold cover have the width of the sum of the cathode assembly, anode assembly, and all the concentrate water assemblies'thicknesses plus the sum of the designated distances between each one of them where the designated distance is on-the-order-of one-tenth-inch plus the distance that the ion exchange membranes protrude into the dilute water space due to the higher pressure of the concentrate water over that of the dilute water,
a manifold faceplate is on-the-order-of three-inch-thick and a manifold cover is on-the-order-of two-inch-thick,
a manifold faceplate has a column of holes on its front face near its left and right edge respectively, that will match the columns of threaded holes on the left and right edges of the outer spacer as described in claim 4, but their hole size will be such they will pass on-the-order-of one-quarter-inch screws rather than be threaded holes,
a manifold faceplate has columns of holes on its front face across its interior between the columns of holes near the left and right edges, that will match the columns of threaded and plain holes on the left and right edges of the inner spacer as described in claim 3, except some of the hole sizes in the manifold faceplate will be so that on-the-order-of one-quarter-inch threaded screws will pass through them rather than be on-the-order-of one-quarter-inch threaded holes,
the locations of the columns of holes in the width direction in a manifold faceplate is such when the anode, cathode, and concentrate water assemblies are stacked back-to-front with a designated distance between them, the columns of holes on the left and right edges in these assemblies match up with the columns of holes on the front face of a manifold faceplate,
a manifold cover has on-the-order-of one-and-one-half-inch deep recessed region on its front face that leaves on-the-order-of a one-inch solid border,
a manifold cover's front face has holes around its perimeter that matches the hole locations and sizes of the holes around the perimeter on the front face of a manifold faceplate, and
a manifold cover has a hole and water fitting on its top side, the hole penetrates the recessed space, and the hole and water fitting is used to feed or retrieve concentrate water into-or-out of the manifold.

7. The electrodialysis stack assembly procedures consist of:
beginning with an anode assembly setting on its lower edge and its anion ion exchange membrane facing directly forward, a concentrate water assembly setting on its lower edge and with its anion ion exchange membrane facing directly forward is set a designated distance in front of the anode assembly. Next a series of concentrate water assemblies setting on their lower edges with their anion ion exchange membranes facing forward are stacked one-after-the-other after the first concentrate water assembly leaving a designated distance between each one. Finally, a cathode assembly setting on its lower edge with its electrode cover facing forward is stacked in front of the last concentrate water assembly that was stacked, while leaving a designated distance between them,
the front of a manifold faceplate along with gaskets, that are setting on their lower edges, is set against the left edges of the anode, cathode, and concentrate water assemblies that were previously stacked, screws are inserted into all the holes in the manifold faceplate, that were made for the screws except for the holes on its perimeter, and these screws are screwed into the anode and concentrate water assemblies,
the front of another manifold faceplate along with gaskets, that are setting on their lower edges, are set against the right edges of the anode, cathode, and concentrate water assemblies that were previously stacked, screws are inserted into all the holes in this manifold faceplate, that were made for the screws except for the holes on its perimeter, and these screws are screwed into the anode and concentrate water assemblies, and
the manifold covers along with gaskets, that are setting on their lower edges and with their recessed regions facing the back of the manifold faceplates, are placed against the manifold faceplates, screws are inserted in the holes around their perimeters on their front faces, the screws pass through holes in the manifold faceplates, and finally the screws are screwed into the anode, cathode, and concentrate water assemblies.

8. The dilute water circulation system consists of:
the invention's electrodialysis stack is set on a ledge within a dilute water reservoir and it is completely submerged in the dilute water filling the dilute water reservoir,
the dilute water below the electrodialysis stack is isolated from the dilute water above the electrodialysis stack except for the dilute water existing in the naturally occurring vertical holes within the electrodialysis stack, and
dilute water is pumped from the dilute water residing below the electrodialysis stack in the dilute water reservoir to a place above the dilute water residing in the dilute water reservoir where it then drops through the air into the dilute water in the dilute water reservoir and finally the dilute water above the electrodialysis stack flows downward though the naturally occurring vertical holes within the electrodialysis stack to the dilute water residing below the electrodialysis stack, which completes the cycle.

9. The concentrate water distribution system consists of:
concentrate water is pumped from a concentrate water reservoir with a holding capacity on-the-order-of five-to-ten gallons to the input of one of the manifolds, flows from this manifold in parallel through the anode, cathode, and concentrate water assemblies in the electrodialysis stack, into-and-out the other manifold, and back to the concentrate water reservoir, which completes the cycle,
periodically with periods on-the-order-of one-hour, the desalination process is interrupted, the supersaturated concentrate water residing in the concentrate water reservoir is sent to a precipitation tank having a holding capacity on-the-order-of a hundred times that of the concentrate water reservoir, the saturated water from the precipitation tank refills the concentrate water reservoir, and the desalination process is resumed, and
salt precipitates out of the supersaturated salt water in the precipitation tank, and is periodically retrieved.

10. The bonding procedures for bonding either the anion and cation exchange membranes to an inner spacer, outer spacer, or retainer sheet consists of:
preparing the outer surfaces of the inner spacer or outer spacer, that will accept an adhesive by sanding, thoroughly cleaning, wiping with isopoll alcohol, drying, painting with a tape primer, and drying for a few minutes,
selecting a double-sided adhesive sheet tape for the adhesive, which is constructed using a central carrier with pressure sensitive low surface energy adhesive on each side of the carrier plus a liner on each side of the adhesives,
preparing a double-sided adhesive sheet tape, by cutting it to size in width and length and then cutting holes in it so that what is left matches the outer surfaces of the inner spacer or outer spacer,
removing the liner from one side of both double-sided adhesive sheet tapes and laying them on a flat horizontal surface with the adhesive portion of the sheet tapes faced upwards,
while aligning the outer surfaces of one side of the inner spacer or outer spacer with the surface of one of the cut double-sided adhesive sheet tapes, the inner spacer or outer spacer is brought down and pressed onto the double-sided adhesive sheet tape laying on a flat horizontal surface with its adhesive pointing upward,
while aligning the outer surfaces of the other side of the inner spacer or outer spacer and the surface of the other cut double-sided adhesive sheet tape, the inner spacer or outer spacer is brought down and pressed onto the double-sided adhesive sheet tape laying on a flat horizontal surface with its adhesive pointing upward,
while pressing down, a roller is used to roll the surfaces on both sides of the inner spacer or outer spacer with the adhered double-sided adhesive sheet tapes on both sides of it,
removing the other liner from one of the double-sided adhesive sheet tapes adhered to the inner or outer spacer,
preparing the anion and cation ion exchange membranes by soaking them in salt water for at least 24 hours where they can expand somewhat in size,
removing the anion ion exchange membrane from the salt water, removing the excess water, painting them with a tape primer where adhesive is to be applied, and drying them for a few minutes,
while aligning the outer surfaces of the inner spacer or outer spacer with the double-sided adhesive sheet tape adhered to it and the anion ion exchange membrane, the inner spacer or outer spacer with the double-sided adhesive sheet tape adhered to it is brought down and pressed onto the anion ion exchange membrane with its primed surface facing up, turned over, and rolled with a roller,
removing the other liner from the other side of the double-sided adhesive sheet tape adhered to the inner spacer or outer spacer,
removing the cation ion exchange membrane from the water, removing the excess water, painting them with a tape primer where adhesive is to be applied, and drying them for a few minutes,
while aligning the outer surfaces of the same inner spacer or outer spacer with the double-sided adhesive sheet tape adhered to it as well as the anion ion exchange membrane, the inner spacer or outer spacer with the other double-sided adhesive sheet tape adhered to it as well as the anion ion exchange membrane is brought down and pressed onto the cation ion exchange membrane with its primed surface facing up, turned over, and rolled with a roller,
while pressing down, a roller is used to roll the surfaces on both sides of the inner spacer or outer spacer with the anion and cation ion exchange membranes adhered to it using double-sided sheet tapes,
the assembly now consisting of anion and cation ion exchange membranes, double-sided adhesive tapes, and inner spacer or outer spacer that are bonded together is set on a flat horizontal surface with the face of either an anion or cation ion exchange membrane facing up. A heavy weight, that will produce on-the-order of two pounds per square inch pressure on the bonded surfaces is set on it for at least 72 hours, which provides time for it to dry and increase its bonding strength,
an alternative to creating pressure on the assembled inner outer spacers, double-sided adhesive tapes, and ion exchange membranes assembly is to use a mechanical press or clamps, and
the bonding of the retainer sheets to the ion exchange membranes follows a similar process as the bonding of the inner spacer or outer spacer to the ion exchange membranes.

11. This invention in conjunction with reverse osmosis provides Zero Liquid Discharge ZLD desalination operation by:
multiple reverse osmosis units are operated in series such that each successive reverse osmosis unit operates on the waste water from the previous one except for the last reverse osmosis unit that operates differently and each reverse osmosis unit in the series provides product desalinated water,
the product desalinated water from each of the reverse osmosis units is combined to provide the final product of desalinated water,
this invention's electrodialysis unit receives the waste water from the last reverse osmosis unit, reduces its salt concentration levels to that of the waste water from the next-to-last reverse osmosis unit, and then sends it to be combined with waste water from the next-to-last reverse osmosis unit for the last reverse osmosis unit to operate on next,
this invention operates with supersaturated concentrate water, but where it is below the salt concentration levels where spontaneous precipitation would occur,
using a time period on-the-order-of an hour, the supersaturated concentrate water is periodically sent to a precipitation tank that is typically one hundred times larger than the concentrate water reservoir's holding capacity and saturated water from the precipitation tank is brought back into the concentrate water reservoir,
solid salt precipitates out of the supersaturated concentrate water in the precipitation tank before it is reused in the concentrate water reservoir, and
the results of the operations separate the input salt water into individual separate quantities of plain water and solid salt which are found at different locations.
